(19) United States
(12) Patent Application Publication
(10) Pub. No.: US 2019/0356912 A1
(43) Pub. Date: Nov. 21, 2019

(54) INFORMATION PROCESSING APPARATUS, INFORMATION PROCESSING METHOD AND COMPUTER-READABLE RECORDING MEDIUM HAVING STORED PROGRAM THEREIN

(71) Applicant: FUJITSU LIMITED, Kawasaki-shi (JP)

(72) Inventor: Hidenobu MIYOSHI, Kawasaki (JP)

(73) Assignee: FUJITSU LIMITED, Kawasaki-shi (JP)

(21) Appl. No.: 16/367,332

(22) Filed: Mar. 28, 2019

(30) Foreign Application Priority Data
May 18, 2018 (JP) 2018-096490

(51) Int. Cl. H04N 19/107; H04N 19/139; H04N 19/172; H04N 19/179

(52) U.S. Cl. CPC H04N 19/107; H04N 19/179; H04N 19/172; H04N 19/139

(57) ABSTRACT

An information processing apparatus includes: a memory; and a processor coupled to the memory and the processor configured to by using image data of an image to be subjected to temporal scalable coding, obtain a motion vector for the image, based on the motion vector, determine whether an image group to be encoded is a still scene, when the image group is determined to be the still scene, add an offset value to an intra-prediction encoding cost of the image included in the image group, based on an intra-prediction encoding cost to which the offset value is added, select an inter-prediction mode in which a predictive image of the image included in the image group is generated by inter-prediction, and by utilizing image data of the predictive image, perform an encoding process on the image data of the image included in the image group.

### CROSS-REFERENCE TO RELATED APPLICATION

This application is based upon and claims the benefit of priority of the prior Japanese Patent Application No. 2018-96490, filed on May 18, 2018, the entire contents of which are incorporated herein by reference.

### FIELD

The embodiments discussed herein are related to an information processing apparatus, an information processing method, and a computer-readable recording medium having stored program therein.

### BACKGROUND

Currently, products using image compression and encoding techniques, such as video cameras and digital versatile disk (DVD) recorders, are in wide use. In the field regarding image compression and encoding, in order to further improve the compression and encoding efficiency, image quality, and so on, active discussions are taking place about the next-generation compression and encoding techniques.

One example of the compression and encoding techniques is international organization for standardization/international electrotechnical commission (ISO/IEC) 23008-2 provided as standard specifications by ISO/IEC (or international telecommunication union telecommunication standardization sector (ITU-T) H.265 “High efficiency video coding”, which may be referred to as “HEVC” hereinafter). HEVC specifies encoding schemes and the like for 4K (=3840×2160 pixels) images and 8K (=7680×4320 pixels) images.

In encoding schemes in HEVC or the like, two types of prediction modes, an intra-prediction mode and an inter-prediction mode, are selectively used for each block within one screen (or picture). “Intra-prediction mode” as used herein is, for example, a mode in which pixels are predicted in the spatial direction from the inside of the current encoding-target picture that has already been encoded. “Inter-prediction mode” as used herein is, for example, a mode in which an image is predicted in the temporal direction from a picture different from the encoding-target picture that has already been encoded. Examples of selection of a prediction mode include the following. For example, with an encoding apparatus, two costs, each of which is taken for the sum of absolute difference (SAD) in pixels between an encoding-target image and a predictive image, are calculated in the intra-prediction mode and in the inter-prediction mode, and then one mode with a smaller cost is selected.

Regarding the HEVC standard, Association of Radio Industries and Business (ARIB) STD-B32 is standardized in Japan. In ARIB STD-B32, temporal scalable coding is prescribed. Temporal scalable coding is, for example, a coding scheme that uses bidirectionally predictive-picture (B-picture) as a reference picture and performs encoding in the time-axis direction (or the temporal direction, or time scalability) with a hierarchical structure.

FIG. 7 is a diagram illustrating an example of a structure of pictures (SOP) of temporal scalable coding prescribed in ARIB STD-B32. The SOP is, for example, a unit describing the encoding order and reference relationship of access units (AUs) when temporal scalable coding is performed. In the case of FIG. 7, 16 pictures constitute one SOP.

In FIG. 7, the vertical axis represents temporary identification (TID) and the horizontal axis represents the display order. “I” denotes an intra-picture (I-picture), “P” denotes a predictive-picture (P-picture), and “B” denotes a B-picture.

In an encoding apparatus, for example, after a picture of a display order “−1” is encoded, a picture of a display order “15” (a picture of TID=0), which is temporally apart from the encoded picture by 15 pictures, is encoded. Next, the encoding apparatus sequentially encodes intermediate pictures by bi-directional prediction. In FIG. 7, a numerical subscript of a B-picture indicates the order of encoding (or decoding).

With the encoding apparatus, 60 Hz substreams (TID=0 to 3) in conformity with the ARIB standards and the remaining 120 Hz substreams (TID=6) are able to be transmitted as single bitstreams. A decoding apparatus can reproduce 60 frames per second (60 Hz) by decoding, out of 16 pictures, pictures of TID=0 to 3 surrounded by a dotted line illustrated in FIG. 7. The decoding apparatus can reproduce 120 frames per second (120 Hz) by decoding all the pictures of TID=0 to 3 and 6 surrounded by a dash-dot line illustrated in FIG. 12.

In such a manner, temporal scalable coding has advantages, such as being able to transmit video data at two frame rates, 120 Hz and 60 Hz, by using a single encoder.

In regard to compression and encoding techniques, for example, the following devices will be mentioned. For example, there is a moving image encoding apparatus that calculates a cost caused by the SAD between an input image signal and a predictive image signal to select a prediction mode, and during an intra-prediction mode, performs an orthogonal transformation by using two types of orthogonal transform units, which perform a first orthogonal transformation in consideration of a prediction direction and a second orthogonal transformation using a discrete cosine transform (DCT) coefficient.

There is also a video encoding device that estimates whether an optimum motion vector is able to be selected near a boundary between slices, and, based on an estimation result, adaptively determines an encoding structure as any one of the SOP structures respectively composed of TID=0, TID=0 and 1, TID=0 to 2, and TID=0 to 3.

There is also a terminal device that calculates a histogram of pixel values (probability distribution of each pixel value) in a local decoded image, identifies, from the calculated histogram, pixels at which noise involved in encoding distortion is superimposed, and corrects the pixel values of the pixels at which the noise is superimposed, to perform encoding.

Examples of the related art include Japanese Laid-open Patent Publication No. 2015-109695, Japanese Laid-open Patent Publication No. 2017-103622, Japanese Laid-open Patent Publication No. 2015-177294, and Japanese Laid-open Patent Publication No. 2017-28337.

### SUMMARY

According to an aspect of the embodiments, an information processing apparatus includes a memory; and a processor coupled to the memory and the processor configured to, by using image data of an image to be subjected to temporal scalable coding, obtain a motion vector for the image, based on the motion vector, determine whether an image group to be encoded is a still scene, when the image group is determined to be the still scene, add an offset value to an intra-prediction encoding cost of the image included in the image group, based on an intra-prediction encoding cost to which the offset value is added, select an inter-prediction mode in which a predictive image of the image included in the image group is generated by inter-prediction, and by utilizing image data of the predictive image, perform an encoding process on the image data of the image included in the image group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of an information processing apparatus;

FIG. 2 is a diagram illustrating an example of a configuration of an intra- and inter-determination unit;

FIG. 3 is a flowchart illustrating an example of operations;

FIG. 4 is a flowchart illustrating an example of operations;

FIG. 5 is a diagram illustrating an example of a hardware configuration of an encoding apparatus;

FIG. 6 is a diagram illustrating an example of a configuration of an information processing apparatus; and

FIG. 7 is a diagram illustrating an example of an SOP structure in temporal scalable coding.

### DESCRIPTION OF EMBODIMENTS

For example, in an encoding apparatus using a compression and encoding technique, an image captured by a camera device (including an imaging device) is compressed and encoded in some cases. However, random noise caused by a camera device or the like is sometimes included in an image. Therefore, there are some cases where, for random noise, a noise removal filter such as a low-pass filter is used to reduce the noise. However, applying a noise removal filter to a super-high-definition video, such as an 8K image, produces a blurred image in which noise is reduced but the quality is poor, causing degradation in image quality in some cases.

When compressing an encoding an image including random noise and being a still scene, the encoding apparatus selects intra-prediction as the prediction mode in some cases. The reason for this will be described in the following.

As described of the above-mentioned technique that performs an orthogonal transformation by using two types of orthogonal transform units, in some cases, an encoding apparatus calculates the cost in an inter-prediction mode and the cost in an intra-prediction mode by using the following equation (1), and selects a prediction mode with a lower cost.

Cost=SAD+λ×bit (1)

In equation (1), for example, λ denotes a scaling parameter, bit denotes the encoding amount of a motion vector, and SAD represents the sum of absolute difference between the pixels in an input image and the corresponding pixels in a predictive image.

In an inter-prediction mode case, the encoding apparatus utilizes a picture whose encoding is already complete, as is, to perform a process of moving the picture by a motion vector to generate a predictive image. Therefore, when random noise is included in an input image, the random noise is also included in a predictive image generated in the inter-prediction mode. When random noise is included in the input image and the random noise is also included in the predictive image, calculating the SAD therebetween results in a very large numerical value. Accordingly, when random noise is included and a still scene is depicted, the numerical value of cost in the inter-prediction mode (equation (1)) is very large.

In contrast, in an intra-prediction mode case, the encoding apparatus performs an averaging process or the like of the pixel values of neighbor pixels in the same picture to generate a predictive image. Therefore, even when random noise is included in an input image, a predictive image without random noise is generated by an averaging process or the like. In this case, calculating the SAD therebetween results in a numerical value lower than in the inter-prediction mode.

Accordingly, when random noise is included and a still scene is depicted, the cost in the intra-prediction mode (equation (1)) is such that (the cost in the intra-prediction mode)<(the cost in the inter-prediction mode). Therefore, with the encoding apparatus, despite the still scene, a predictive image is generated in the intra-prediction mode and an encoding process is performed, in some cases.

By decoding encoded data that is obtained by performing the encoding process in the intra-prediction mode on an input image including random noise and being a still scene, an image in which the random noise is decreased or lost by an averaging process or the like is obtained as described above.

Accordingly, in such a case, when, in the encoding apparatus, the encoding process is performed in the intra-prediction mode, a decoded image faithful to an input image is unable to be obtained in some cases. Therefore, when, in the encoding apparatus, the intra-prediction mode is selected for an input video including random noise and being a still scene, the image quality is degraded in some cases.

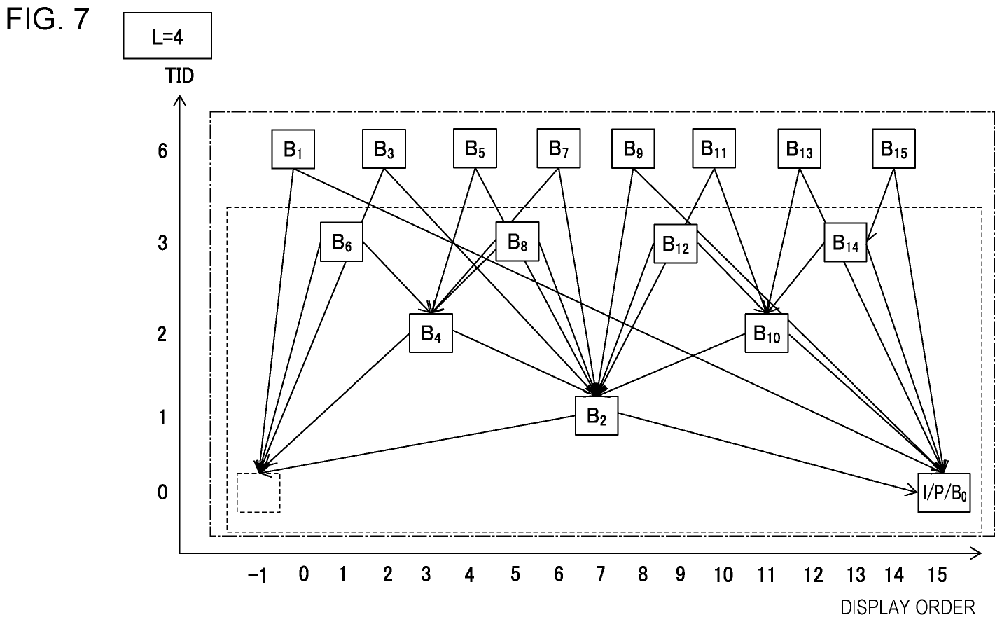

In temporal scalable coding, for example, as illustrated in FIG. 7, intermediate pictures of B₁ to B₁₅ have a relationship in which they reference an I-picture of TID=0 and reference a B-picture that has referenced the I-picture. In the intermediate pictures of B₁ to B₁₅ that have referenced the I-picture generated in the intra-prediction mode, an image in which random noise is lost due to the intra-prediction mode is copied, so that predictive images are generated, and therefore, in some cases, these images are also images in which random noise is lost. Accordingly, also in temporal scalable coding, image quality is degraded in some cases.

Regarding any techniques described above, no measures against such degradation in image quality are suggested.

Hereinafter, embodiments of the present application will be described in detail with reference to the accompanying drawings. Challenges and implementations in the present specification are exemplary and are not intended to limit the scope of the present application. Embodiments may be combined as appropriate to the extent that the processing details thereof are not inconsistent herewith. As the terms and technical contents described herein, the terms and technical contents described in the standard documents related to compression and encoding of images, such as ISO/IEC, may be used as appropriate.

### First Embodiment

Example of Configuration of Information Processing Apparatus (or Encoding Apparatus)

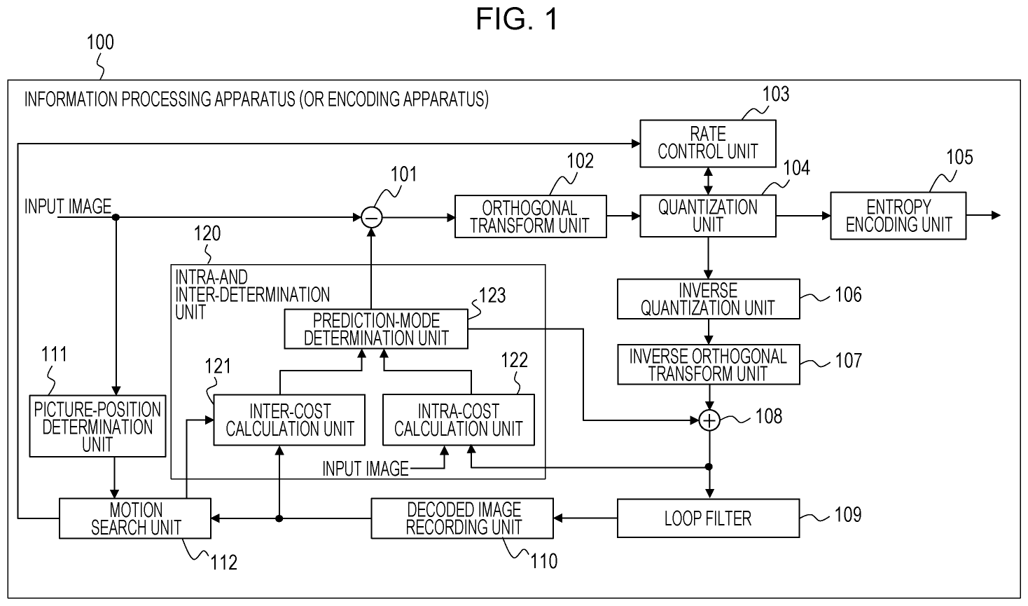

FIG. 1 is a diagram illustrating an example of a configuration of an information processing apparatus 100 according to a first embodiment of the present application. In FIG. 1, an example of a configuration of an encoding apparatus, as an exemplary information processing apparatus, is illustrated. An information processing apparatus may be referred to as an encoding apparatus hereinafter.

The encoding apparatus 100 performs, for example, a compression and encoding process in compliance with the requirements of HEVC on the image data of an input image. For example, the encoding apparatus 100 performs, for example, a temporal scalable coding process prescribed in ARIB STD-B32 or the like. The encoding apparatus 100 performs a temporal scalable coding process on the image data of an input image to generate encoded data in a first layer (for example, TID=6) that will be used when reproduced at a first frame rate. The encoding apparatus 100 also generates encoded data in a second layer (for example, TID=0 to 3) that will be used when reproduced at a second frame rate lower than the first frame rate. The encoding apparatus 100 is capable of transmitting the encoded data in the two layers, for example, collectively as single bitstreams to a decoding apparatus.

The encoding apparatus 100 includes a subtraction unit 101, an orthogonal transform unit 102, a rate control unit 103, a quantization unit 104, an entropy encoding unit 105, an inverse quantization unit 106, an inverse orthogonal transform unit 107, a decoded image generation unit 108, a loop filter 109, and a decoded image recording unit 110. The encoding apparatus 100 also includes a picture-position determination unit 111, a motion search unit 112, and an intra- and inter-determination unit 120. The intra- and inter-determination unit 120 includes an inter-cost calculation unit 121, an intra-cost calculation unit 122, and a prediction-mode determination unit 123.

The subtraction unit 101 subtracts the image data of a predictive image output from the intra- and inter-determination unit 120 from the image data of an input image to generate the image data of a difference image. Examples of the predictive image include a predictive image generated in an intra-prediction mode and a predictive image generated in an inter-prediction mode. The subtraction unit 101 outputs the image data of the difference image to the orthogonal transform unit 102.

The term “moving image” may be referred to as “video”, and “image” and “video” may be used without discrimination from each other hereinafter. “Image” and “image data” may also be used without discrimination from each other.

The orthogonal transform unit 102 performs, for example, integer conversion on a per-transform unit (TU) basis on the image data of a difference image to convert the image data to image data in the frequency domain. The orthogonal transform unit 102 outputs to the quantization unit 104 the difference image after the integer conversion.

The rate control unit 103 determines quantization parameters including a quantization step and the like, based on motion information output from the motion search unit 112. The rate control unit 103 outputs the quantization parameters to the quantization unit 104.

The quantization unit 104 calculates a quantized value of the image data of the difference image after the integer conversion by dividing the image data by the quantization step included in the quantization parameters. The quantization unit 104 performs such a quantization process on a per-TU basis. The quantization unit 104 outputs the calculated quantized value to the entropy encoding unit 105 and the inverse quantization unit 106.

The entropy encoding unit 105 encodes a quantized value and the like by utilizing arithmetic coding, context-adaptive binary arithmetic coding (CABAC). The entropy encoding unit 105 outputs encoded image data.

The encoded image data is, for example, output to an interface (IF) processing unit or the like. In the IF processing unit, encoded image data is transmitted as bitstreams including 60 Hz substreams (TID=0 to 3) and the remaining 120 Hz substreams (TID=6) to a decoding apparatus.

The subtraction unit 101, the orthogonal transform unit 102, the quantization unit 104, and the entropy encoding unit 105 may be included as encoding processing units.

The inverse quantization unit 106, for example, multiplies a quantized value by the quantization step used by the quantization unit 104 to calculate integer-converted image data that is yet to become a quantized value.

The inverse orthogonal transform unit 107 performs an inverse integer conversion process on the image data output from the inverse quantization unit 106 to generate a difference image before integer conversion.

The decoded image generation unit 108 adds the difference image output from the inverse orthogonal transform unit 107 and a predictive image output from the prediction-mode determination unit 123 together to generate a decoded image. The decoded image generation unit 108 outputs the generated decoded image to the loop filter 109.

The loop filter 109 performs, on the decoded image, for example, a filtering process for reducing encoding distortion. The loop filter 109 records the filtered decoded image in the decoded image recording unit 110.

The decoded image recording unit 110 is, for example, a memory. The decoded image recording unit 110 is, for example, capable of recording decoded images corresponding to a plurality of pictures in order to be able to generate a predictive image in the reference relationship illustrated in FIG. 7.

The picture-position determination unit 111 determines, for example, whether an input image (or an image to be encoded) is an image corresponding to a picture at the shallowest layer (TID=0) in terms of the unit representing the encoding order and reference relationship among pictures in temporal scaling coding. For example, the picture-position determination unit 111 determines whether the input image is an image corresponding to a picture included in the shallowest layer (TID=0) in an SOP. A more detailed discussion will be given in the Operation Example section. The picture-position determination unit 111 outputs the input image and a determination result to the motion search unit 112.

The motion search unit 112 obtains motion information, such as a motion vector, by using a decoded image read from the decoded image recording unit 110 and an input image output from the picture-position determination unit 111. For example, assuming that the input image is an image to be encoded and the decoded image is a reference image, the motion search unit 112 obtains a motion vector and the like by utilizing the reference relationship illustrated in FIG. 7. In this case, the motion search unit 112 performs a block-matching process between the image to be encoded and the reference image on a per-prediction block (PB) (hereinafter referred to simply as “block” in some cases) size basis to obtain the motion vector.

The inter-cost calculation unit 121 generates an inter-predictive image that is moved from the input image received from the motion search unit 112 by an amount of the motion vector obtained by the motion search unit 112. For example, the inter-cost calculation unit 121 generates an inter-predictive image on a per-PB size basis.

By using the input image and the generated inter-predictive image, the inter-cost calculation unit 121 calculates inter sum-of-absolute-difference (InterSAD) between the co-located pixels in the two images. For example, the inter-cost calculation unit 121 calculates InterSAD by using the following equation (2).

InterSAD=Σ|OrgPixel−PredPixel| (2)

In equation (2), OrgPixel denotes the pixel value of each pixel of the input image and PredPixel denotes the pixel value of each pixel of the inter-predictive image.

The inter-cost calculation unit 121 calculates the cost of the inter-predicted image, InterCost, for example, by using the following equation (3).

InterCost=InterSAD+λ×inter_bit (3)

In equation (3), λ denotes a scaling parameter and inter_bit denotes an encoding amount regarding prediction information (a motion vector, a PB size, and the like).

For example, the inter-cost calculation unit 121 retains equation (2), equation (3), and λ in an internal memory, and, during processing, reads equation (2) and equation (3) and substitutes each pixel value and the like in equation (2) and equation (3) to calculate InterSAD and InterCost.

Calculation of InterSAD may be, for example, by the motion search unit 112. In this case, the inter-cost calculation unit 121 outputs the generated inter-predictive image to the motion search unit 112, and the motion search unit 112 calculates InterSAD by using the inter-predictive image and the input image and utilizing equation (2) stored in the internal memory. The motion search unit 112 outputs the calculated InterSAD to the inter-cost calculation unit 121, and the inter-cost calculation unit 121 calculates InterCost by utilizing equation (3).

Calculations of InterSAD, InterCost, and IntraCost may be, for example, performed on a per-block basis.

The inter-cost calculation unit 121 outputs InterCost and the generated inter-predictive image to the prediction-mode determination unit 123.

The intra-cost calculation unit (or addition unit) 122 generates an intra-predictive image by using a decoded image output from the decoded image generation unit 108. For example, the intra-cost calculation unit 122 performs spatial prediction by, for example, averaging or smoothing the pixel values of pixels of a decoded image that has already been encoded, the pixels neighboring to a block to be predicted, thereby generating an intra-predictive image. For example, the intra-cost calculation unit 122 generates an intra-predictive image on a per-PB size basis.

The intra-cost calculation unit 122 also calculates intra sum-of-absolute-difference (IntraSAD) between the co-located pixels in the input image and the intra-predictive image. For example, the intra-cost calculation unit 122 calculates IntraSAD by using the following equation (4).

IntraSAD=Σ|OrgPixel−PredPixel| (4)

In equation (4), OrgPixel denotes the pixel value of each pixel in the input image and PredPixel denotes the pixel value of each pixel in the intra-predictive image.

Then the intra-cost calculation unit 122 calculates the cost of the intra-predictive image, IntraCost, for example, by using the following equation (5).

IntraCost=IntraSAD+λ×intra_bit (5)

In equation (5), Intra_bit denotes an encoding amount regarding prediction information (a PB size and the like).

In the first embodiment, when an SOP is determined to be a still scene, the intra-cost calculation unit 122 adds an OFFSET value (>0) to IntraCost expressed by equation (5) for all the pictures in the SOP. Thus, with the encoding apparatus 100, during selection of a prediction mode, InterCost<IntraCost+OFFSET value, and thus, in the SOP, an encoding process may be performed such that an inter-predictive image, not an intra-predictive image, is selected. Details thereof will be described in the Operation Example section. Therefore, the intra-cost calculation unit 122 may be, for example, an addition unit that adds an OFFSET value to IntraCost.

For example, the intra-cost calculation unit 122 stores equation (4), equation (5), and λ in an internal memory, and, during processing, reads equation (4) and equation (5) from the internal memory and substitutes each pixel value and the like in equation (4) and equation (5) to calculate IntraSAD and IntraCost.

The prediction-mode determination unit 123 compares InterCost output from the inter-cost calculation unit 121 with IntraCost output from the intra-cost calculation unit 122 and selects a prediction mode with a smaller value. For example, if InterCost<IntraCost, the prediction-mode determination unit 123 selects the inter-prediction mode and outputs to the subtraction unit 101 an inter-predictive image output from the inter-cost calculation unit 121. If InterCost>IntraCost, the prediction-mode determination unit 123 selects the intra-prediction mode and outputs to the subtraction unit 101 an intra-predictive image output from the intra-cost calculation unit 122.

In the first embodiment, when an input image is determined to be a still scene, an OFFSET value is added to IntraCost and therefore InterCost<IntraCost+the OFFSET value, and the prediction-mode determination unit 123 selects the inter-prediction mode.

The prediction-mode determination unit 123 outputs to the subtraction unit 101 a predictive image of the selected prediction mode.

Example of Configuration of Intra-and Inter-Determination Unit

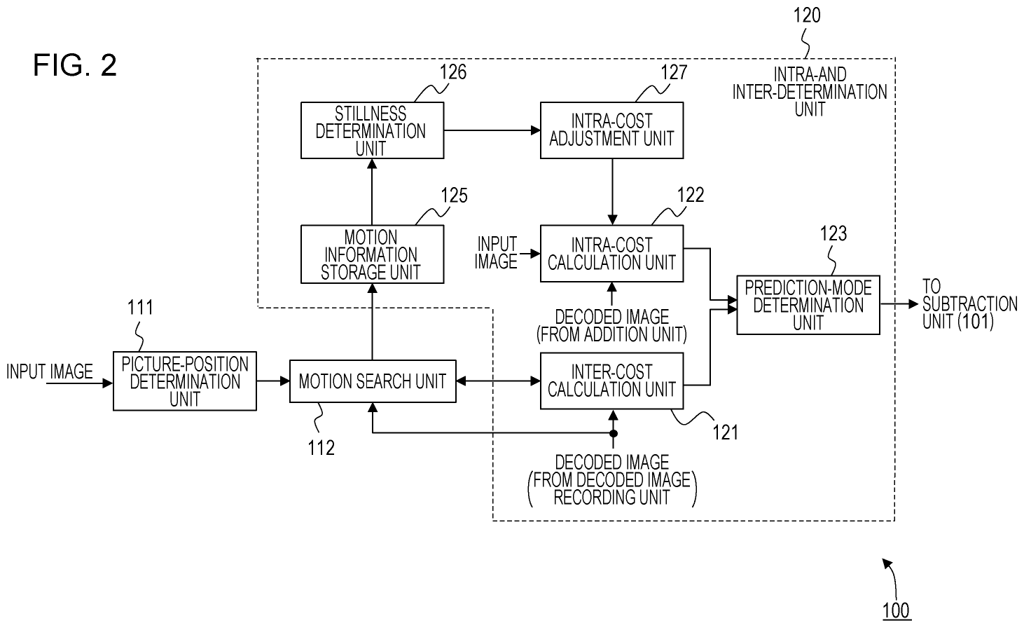

FIG. 2 is a diagram illustrating an example of a configuration of the intra- and inter-determination unit 120. In FIG. 2, an example in which the motion search unit 112 receives an inter-predictive image from the inter-cost calculation unit 121 and calculates InterSAD is illustrated.

As illustrated in FIG. 2, the intra- and inter-determination unit 120 further includes a motion information storage unit 125, a stillness determination unit 126, and an intra-cost adjustment unit 127.

The motion information storage unit 125 is, for example, a memory and stores therein motion information (for example, a motion vector and InterSAD) output from the motion search unit 112.

The stillness determination unit 126 determines, based on motion information, whether the SOP is a still scene. The reason why the stillness determination unit 126 determines whether the SOP is a still scene is, for example, as follows.

As illustrated in FIG. 7, a picture of TID=0 in the SOP (for example, a picture of P or B₀) is encoded with reference to an I-picture or a P-picture that is 15 pictures prior thereto in the display order. The picture of TID=0 is longer in terms of reference distance than the other pictures in the SOP. In pictures in the SOP that are temporally consecutive in the SOP, when the picture of TID=0 is a still scene, there is a low possibility that the other intermediate pictures (from the B₁ picture to the B₁₅ picture) will be motion scenes (or scenes in which an object seems to be moving, the scenes being referred to as “motion scenes” in some cases hereinafter), and there is a high possibility that they will be still scenes. Therefore, the stillness determination unit 126 determines whether the picture of TID=0 is a still scene, and avoid making determinations for intermediate pictures.

The stillness determination unit 126 determines whether a still scene is determined, for example, based on the motion vector of the picture of TID=0. The stillness determination unit 126 performs the following.

For example, the stillness determination unit 126 reads a motion vector (xi, yi) (i being from one to the number of PBs in the picture) in each block of the picture of TID=0 from the motion information storage unit 125 and calculates the average (mvx, mvy) thereof. The stillness determination unit 126 compares the average of motion vectors to a stillness determination threshold Still_Th. When |mvx|+|mvy|<Still_Th, the stillness determination unit 126 determines that the SOP is a still scene, and otherwise, determines that the SOP is not a still scene (a motion scene). In this way, the stillness determination unit 126 determines, based on the motion vector of the picture of TID=0, whether the entire SOP is a still scene.

With reference now to FIG. 2, the stillness determination unit 126 outputs to the intra-cost adjustment unit 127 a determination result and InterSAD read from the motion information storage unit 125.

When the determination result is that the SOP is a still scene, the intra-cost adjustment unit 127 calculates an OFFSET value (or an offset value) greater than “0”. The intra-cost adjustment unit 127 may, for example, calculate the OFFSET value based on InterSAD or determine a fixed value stored in an internal memory as the OFFSET value.

If the OFFSET value is set to the fixed value, the fixed value is, for example, a value that satisfies InterCost<IntraCost+OFFSET value. This is for the purpose of allowing the prediction-mode determination unit 123 to select the inter-prediction mode.

Examples of the case where the intra-cost adjustment unit 127 calculates an OFFSET value based on InterSAD include the following three cases.

The first case is that statistics are adaptively controlled on a per-block basis. For example, the motion search unit 112 calculates InterSAD on a per-block (for example, PB) basis by using equation (2), and the intra-cost adjustment unit 127 calculates an OFFSET value based on InterSAD on a per-block basis. Assuming that OFFSET value=InterSAD×k (K>0), the intra-cost adjustment unit 127 calculates an OFFSET value that satisfies InterCost<IntraCost+OFFSET value. Here, k is, for example, an adjustment coefficient. For example, when random noise is included in an input video, InterSAD has a higher value than IntraSAD as described above. Accordingly, the possibility that InterCost<IntraCost+InterSAD×k increases.

The second case is that statistics are adaptively controlled on a per-picture basis. For example, the intra-cost adjustment unit 127 calculates an OFFSET value based on a mean of InterSAD of encoded pictures of the same type (for example, of the same TID or at the same position in encoding order in the SOP illustrated in FIG. 7).

For example, the motion search unit 112 calculates InterSAD on a per-block basis for one image, and the intra-cost adjustment unit 127 may calculate an OFFSET value based on the average InterSAD obtained by averaging calculation results by the number of blocks in one picture.

In addition, for example, when an image corresponding to two B-pictures (B₄ and B₁₂) of TID=2 is to be encoded, the intra-cost adjustment unit 127 may calculate an OFFSET value based on the average InterSAD obtained by averaging the values of InterSAD of the two B-pictures (B₄ and B₁₂) in an SOP, which is one to several SOPs prior to the current SOP, the values of InterSAD being calculated by the motion search unit 112.

Furthermore, for example, when the B₄ picture of TID=2 is to be encoded, the intra-cost adjustment unit 127 may perform a calculation based on the mean InterSAD obtained by averaging the values of InterSAD of a plurality of B₄ pictures of an SOP, which is several SOPs prior to the current SOP, the values of Inter SAD being calculated by the motion search unit 112.

In any example of the second case, the intra-cost adjustment unit 127 calculates an OFFSET value that satisfies InterCost<IntraCost+OFFSET value, assuming that OFFSET value=average InterSAD×k.

The third case is that statistics are adaptively controlled on a per-SOP basis. For example, the intra-cost adjustment unit 127 uses average InterSAD of TID=0 to calculate an OFFSET value in intermediate pictures of the SOP. Assuming that OFFSET value=(average InterSAD of TID=0)×k, the intra-cost adjustment unit 127 calculates an OFFSET value that satisfies InterCost<IntraCost+the OFFSET value. Since the pictures of TID=0 are farthest away from each other in the SOP, the average InterSAD of TID=0 can be an upper limit for the intermediate pictures in the SOP. When a picture of TID=0 is in the inter-prediction mode, any pictures in the SOP are also in the inter-prediction mode, presenting no irregularity. In view of the above, the third case is an example of calculating an OFFSET value by using average InterSAD of TID=0.

The intra-cost adjustment unit 127 outputs the calculated OFFSET value to the intra-cost calculation unit 122. If the determination result is that the SOP is not a still scene, the intra-cost adjustment unit 127 sets the OFFSET value to “0”.

Although, as described above, the intra-cost calculation unit 122 calculates the cost of an intra-predictive image, IntraCost; however, when it is determined by the stillness determination unit 126 that the SOP is a still scene, the intra-cost calculation unit 122 calculates IntraCost to which an OFFSET value is added. The intra-cost calculation unit 122 calculates

IntraCost=IntraSAD+λ×intra_bit+OFFSET value (6)

For example, upon receiving an OFFSET value from the intra-cost adjustment unit 127, the intra-cost calculation unit 122 reads equation (6) from the internal memory and substitutes the OFFSET value and IntraSAD in equation (6) to calculate IntraCost. Alternatively, the intra-cost calculation unit 122, for example, calculates equation (4) and equation (5) and adds the OFFSET value to a result of equation (5). The intra-cost addition unit 122 outputs to the prediction-mode determination unit 123 the intra-predictive image and IntraCost after the addition.

As described above, the prediction-mode determination unit 123 compares IntraCost output from the intra-cost calculation unit 122 with InterCost output from the inter-cost calculation unit 121 and selects a prediction mode with a lower cost. When the SOP is determined to be a still scene, since IntraCost to which an OFFSET value is added is calculated by the intra-cost adjustment unit 127, the prediction-mode determination unit 123 determines that InterCost<IntraCost (+OFFSET value). Accordingly, in the case of a still scene, the prediction-mode determination unit 123 selects inter-prediction and outputs a predictive image thereof to the subtraction unit 101.

### Operation Example

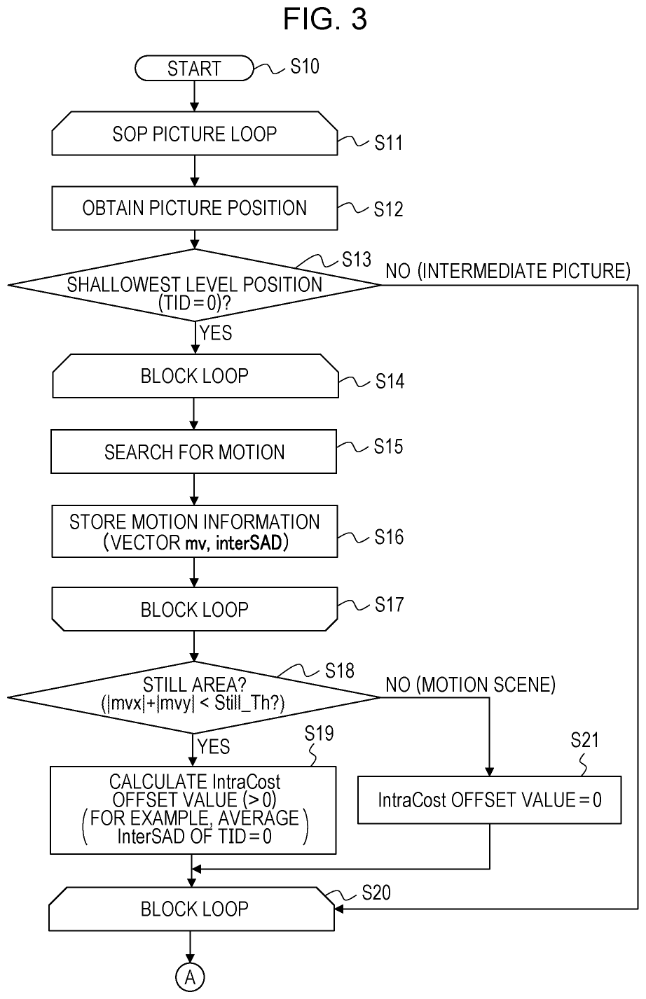

FIG. 3 is a flowchart illustrating an example of operations.

The encoding apparatus 100 starts a process (S10) and repeats S12 to S25 for each picture in a SOP (S11).

The encoding apparatus 100 obtains a picture position in the SOP for an input image (S12). For example, upon receiving the image data of the input image, the picture-position determination unit 111 counts the number of images (or the number of pictures) of input images and obtains the count value, thereby obtaining a picture position in the SOP. For example, when the count value is “1”, the picture-position determination unit 111 determines that the input image is a picture of TID=0 (for example B₀), and when the count value is between “2” and “15”, the picture-position determination unit 111 determines that the input image is a picture of TID=1, 2, 3, or 6. In this case, since, for example, the number of pictures in the SOP is limited to “16”, the picture-position determination unit 111 is reset to “1” if the count value has reached “16”.

Next, the encoding apparatus 100 determines whether the input image is a picture at the shallowest level position (S13). For example, the picture-position determination unit 111 determines that the picture with a count value “1” is a picture at the shallowest-level position (TID=0) in the SOP (YES in S13), and determines that a picture with another count value is not the picture at the shallowest-level position (NO in S13).

If the input image is determined to be a picture at the shallowest-level position (YES in S13), the encoding apparatus 100 repeats S15 and S16 for each block (for example, PB).

For example, the encoding apparatus 100 searches a decoded image read from the decoded image recording unit 110 for a motion on a per-predetermined block basis to obtain motion information (S15). For example, the encoding apparatus 100 performs the following.

For example, the motion search unit 112 obtains motion information by using the input image and the decoded image and outputs a motion vector to the inter-cost calculation unit 121. The inter-cost calculation unit 121 generates a predictive image in the inter-prediction mode by using the motion vector and the decoded image and outputs the predictive image to the motion search unit 112. The motion search unit 112 calculates InterSAD by using the input image and the predictive image and utilizing equation (2).

Next, the encoding apparatus 100 stores the motion information in the motion-information storage unit 125 (S16). For example, the motion search unit 112 stores InterSAD and the motion vector as the motion information in the motion-information storage unit 125. The encoding apparatus 100 searches for a motion in the input image determined to be TID=0 (S15) and stores motion information in the motion information storage unit 125 (S16).

The encoding apparatus 100 performs search for a motion (S15) and storage of motion information (S16) on a per-block basis, and, upon completion of S15 and S16 for all the blocks in the picture (S17), proceeds to S18.

In S18, the encoding apparatus 100 determines, based on the motion information, whether the input image (or SOP) is a still area (or still scene) (S18). For example, the encoding apparatus 100 performs the following.

For example, the stillness determination unit 126 reads the motion vector of the picture of TID=0 from the motion-information storage unit 125 and calculates the mean (mvx, mvy). When |mvx|+|mvy|<Still_Th, the stillness determination unit 126 determines that the SOP is a still scene (YES in S18), and otherwise determines that the SOP is not a still scene (NO in S18).

If the encoding apparatus 100 determines that the SOP is a still scene (YES in S18), the encoding apparatus 100 calculates an OFFSET value of IntraCost (>0) (S19). For example, the intra-cost adjustment unit 127 may read a fixed value from the internal memory and set the OFFSET value to the fixed value, or may set the OFFSET value to a mean of InterSAD of pictures at the same TID level in the SOP among pictures that have already been encoded.

The encoding apparatus 100 then proceeds to S20.

If, however, the encoding apparatus 100 determines that the input image (or the SOP) is not a still area (NO in S18), the encoding apparatus 100 sets the OFFSET value of IntraCost to zero (S21).

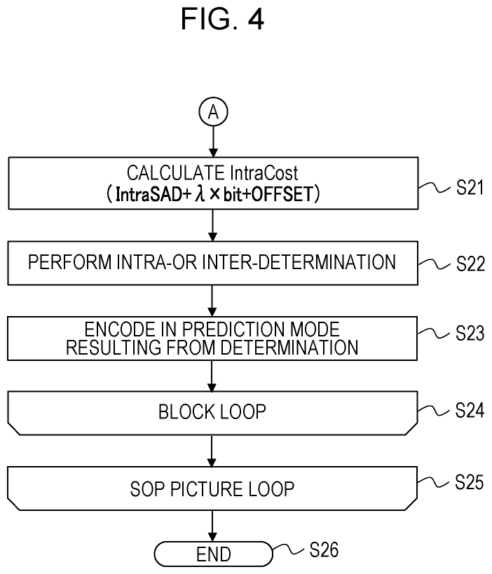

If, however, the input image is not a picture at the shallowest level position (NO in S13), the encoding apparatus 100 proceeds to S20 without performing S14 to S19 and S21 in FIG. 4.

In S20, the encoding apparatus 100 repeats S21 to S24 for each prediction block (for example, PB) of the input image.

The encoding apparatus 100 calculates IntraCost (S21). For example, the intra-cost calculation unit 122 calculates IntraCost by using equation (6). As described above, for the calculation of an OFFSET value, a fixed value may be used or average InterSAD may be used.

Next, the encoding apparatus 100 determines whether to select the intra-prediction mode or the inter-prediction mode (S22). For example, in the case of a still scene, since an OFFSET value is added to IntraCost, the prediction-mode determination unit 123 determines that InterCost<IntraCost and selects the inter-prediction mode.

Next, the encoding apparatus 100 performs an encoding process in the determined prediction mode (S23). For example, in the case of a still scene, the prediction-mode determination unit 123 outputs to the subtraction unit 101 a predictive image generated by inter-prediction, which is then subjected to an encoding process performed by the subtraction unit 101 and the subsequent units, and thus encoded image data is output from the entropy encoding unit 105.

Upon repeating S21 to S23 for all the blocks of the input image (a loop from S20 to S24), the encoding unit 100 causes the next input image to be input and performs S11 to S24. The encoding apparatus 100 performs this (a loop from S11 to S24) for input images corresponding to all the pictures in the SOP.

The encoding apparatus 100 then completes a series of steps (S28).

In the first embodiment, even for a picture of TID=0 that is, for example, an input image to be encoded as an I-picture in the SOP, when the picture is determined to be a still scene, a predictive image is generated in the inter-prediction mode and is encoded. Alternatively or additionally, when all the pictures of TID=0 are determined to be still scenes, predictive images are generated in the inter-prediction mode and are encoded.

As described above, in the case of inter-predication, the encoding apparatus 100 uses a reference image, as is, to generate a predictive image whereas, in the case of intra-prediction, the encoding apparatus 100 performs an averaging process or the like of the pixel values of encoded pixels to generate a predictive image. Accordingly, in an inter-predictive image, random noise in an input image is corrected less than in an intra-predictive image, and thus a predictive image may be obtained in a manner where the random noise remains intact.

Accordingly, in the encoding apparatus 100, since a predictive image is generated in the inter-prediction mode even when random noise is included in an input image, encoded data in which the random noise remains is more likely to be obtained than when a predictive image is generated in the intra-prediction mode. When such encoded data is decoded by a decoding apparatus, a decoded image in which random noise of the input image remains is more likely to be obtained. Such an encoding process may be said as an encoding process faithful to an input image.

Alternatively or additionally, in the first embodiment, the encoding apparatus 100 may perform a series of processes only when a picture is TID=0 and is an inter-predictive picture (a B-picture or a P-picture). In this case, in the encoding apparatus 100, an I-picture in which random noise remains may be generated in such a way that the amount of information of an I-picture is increased to the extent that the image quality of the I-picture is at the level of the original image. In this case, in the encoding apparatus 100, although the amount of information assigned to a B-picture is reduced, encoding in the inter-prediction mode enables the random noise in the I-picture to be copied, enabling a B-picture in which random noise remains to be generated.

In addition, in the encoding apparatus 100, for intermediate pictures (TID=1 to 3, and 6) in the SOP, predictive images are generated by inter-prediction by referencing a picture of TID=0 encoded in such a manner. Therefore, even for the intermediate pictures, decoded images in which random noise of the input image remains may be obtained, as compared with the case of the intra-prediction mode.

Furthermore, when an input image is a super-high-definition image such as an 8K image, an edge portion of the image is also clear. For such an input image, the encoding apparatus 100 encodes all the pictures in the SOP in the inter-prediction mode, and therefore may obtain decoded images whose edge portions remain clear, as compared with the case of the intra-prediction mode.

In contrast, when an input image includes random noise and is a motion scene, the magnitudes of motion vectors before and after the picture are large, as compared with the case of a still scene. In such a situation, if the two cost calculation units 121 and 122 calculate InterCost and IntraCost, there are some cases where an inter-predictive image is larger in SAD and in the encoding amount of motion vectors than an intra-predictive image. Thus, InterCost>IntraCost, and there is a high possibility that the prediction-mode determination unit 123 selects the intra-prediction mode. In the inter-prediction mode, a motion vector is searched for on a per-block basis; however, in the case of a motion scene, because the difference between an input image and a decoded image is large, a motion vector is not accurately detected in some cases. In such a situation, selecting the inter-prediction mode leads to degradation in image quality in some cases. In the encoding apparatus 100, in the case of a motion scene, since the intra-prediction mode is selected based on cost calculation, such degradation in image quality may be reduced.

From the above, the encoding apparatus 100 in the first embodiment may reduce degradation in image quality.

In the encoding apparatus 100, even when, for a picture of TID=0, a predictive image is generated in the inter-prediction mode, the relationship illustrated in FIG. 7, for example, is maintained as the relationship among intermediate pictures.

### Other Embodiments

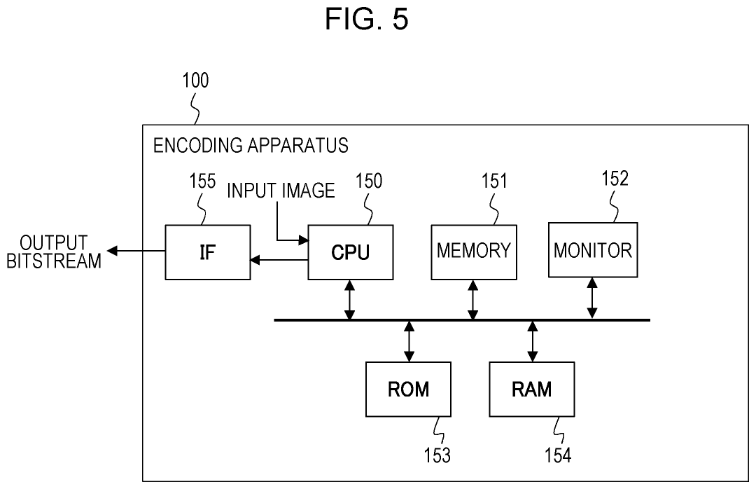

FIG. 5 is a diagram illustrating an example of a hardware configuration of the encoding apparatus 100.

The encoding apparatus 100 includes a central processing unit (CPU) 150, a memory 151, a monitor 152, a read only memory (ROM) 153, a random access memory (RAM) 154, and an interface (IF) 155.

The CPU 150 reads a program stored in the ROM 153 to load the program into the RAM 154, and executes the loaded program. This execution causes the CPU 150 to implement the functions of the subtraction unit 101, the orthogonal transform unit 102, the rate control unit 103, the quantization unit 104, the entropy encoding unit 105, the inverse quantization unit 106, the inverse orthogonal transform unit 107, the decoded image generation unit 108, and the loop filter 109. The execution also causes the CPU 150 to implement the functions of the picture-position determination unit 111, the motion search unit 112, and the intra- and inter-determination unit 120. Accordingly, the CPU 150 corresponds to, for example, the subtraction unit 101, the orthogonal transform unit 102, the rate control unit 103, the quantization unit 104, the entropy encoding unit 105, the inverse quantization unit 106, the inverse orthogonal transform unit 107, the decoded image generation unit 108, and the loop filter 109. The CPU 150 also corresponds to, for example, the picture-position determination unit 111, the motion search unit 112, and the intra- and inter-determination unit 120.

The monitor 152, for example, displays an input image under the control of the CPU 150.

The memory 151 corresponds to, for example, the decoded image recording unit 110 and the motion information storage unit 125 and stores therein equations (2) to (6) and λ.

The IF 155 converts encoded data received from the CPU 150 into a format in which the data can be transmitted to a decoding apparatus, and transmits bitstreams after the conversion to the decoding apparatus.

The CPU 150 may include a micro processing unit (MPU) or a digital signal processor (DSP), a field programmable gate array (FPGA), or the like. A CPU, an MPU, a DSP, or a FPGA is sometimes called a processor. The CPU 150 may be a single CPU, a multi-CPU, or a multi-core CPU.

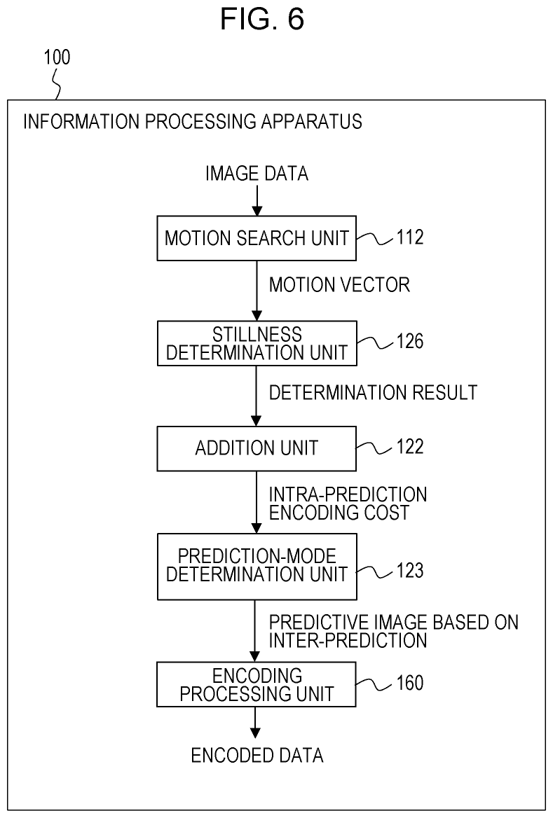

FIG. 6 is a diagram illustrating an example of a configuration of the information processing apparatus 100.

The information processing apparatus 100 performs temporal scalable coding on image data. The information processing apparatus 100 includes the motion search unit 112, the stillness determination unit 126, the addition unit 122, the prediction-mode determination unit 123, and the encoding processing unit 160.

By using the image data of an image to be subjected to temporal scalable coding, the motion search unit 112 obtains a motion vector for the image.

The stillness determination unit 126 determines, based on the motion vector, whether an image group to be subjected to temporal scalable coding is a still scene.

When the image group is determined to be a still scene, the addition unit 122 adds an offset value to the intra-prediction encoding cost of an image included in the image group.

Based on the intra-prediction encoding cost to which the offset value is added, the prediction-mode determination unit 123 selects the inter-prediction mode in which a predictive image of the image included in the image group is generated by inter-prediction.

By utilizing image data of the predictive image, the encoding processing unit 160 performs an encoding process on the image data of the image included in the image group.

In this way, in the information processing apparatus 100, upon a determination that the image group is a still scene, an offset value is added to the intra-prediction encoding cost, and therefore the inter-prediction mode is selected as a prediction mode. The information processing apparatus 100 then generates a predictive image by inter-prediction to perform an encoding process.

In the encoding apparatus 100, if the intra-prediction mode is selected, the pixel values of pixels of a predictive image are obtained, for example, by averaging the pixel values of encoded pixels. Therefore, in the encoding apparatus 100, even when random noise is included in an input image, encoded data in which random noise is small or lost is obtained. In this case, when the encoded data is decoded, the decoded image is an image in which random noise is small or is lost, which is different from the input image.

In contrast, in the information processing apparatus 100, a predictive image is generated in the inter-prediction mode. Since, in the inter-prediction mode, the information processing apparatus 100 generates a predictive image by using a decoded image including random noise, as is, and therefore encoded data in which random noise remains may be obtained. Even when such encoded data is decoded by a decoding apparatus, a decoded image in which random noise remains and that is faithful to the input image may be obtained.

In this way, in the information processing apparatus 100, in the case of a still scene, since not the intra-prediction mode but the inter-prediction mode is selected, encoded data faithful to an input image may be obtained. Accordingly, in the information processing apparatus 100, degradation in image quality may be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
by using image data of an image to be subjected to temporal scalable coding, obtain a motion vector for the image,
based on the motion vector, determine whether an image group to be encoded is a still scene,
when the image group is determined to be the still scene, add an offset value to an intra-prediction encoding cost of the image included in the image group,
based on an intra-prediction encoding cost to which the offset value is added, select an inter-prediction mode in which a predictive image of the image included in the image group is generated by inter-prediction, and
by utilizing image data of the predictive image, perform an encoding process on the image data of the image included in the image group.

2. The information processing apparatus according to claim 1,
wherein the processor is further configured to
determine whether the image is an image corresponding to a picture at a shallowest level in terms of a unit representing an encoding order and a reference relationship of a picture in temporal scalable coding,
when the image is an image corresponding to the picture at the shallowest level, obtain a motion vector for the image, and
based on the motion vector, determine whether the image group is a still scene.

3. The information processing apparatus according to claim 2,
wherein the picture at the shallowest level is a picture with temporary identification (TID) “0” in a structure of pictures (SOP) in temporal scalable coding.

4. The information processing apparatus according to claim 1,
wherein the processor is further configured to
when the image group is determined to be the still scene, calculate the offset value greater than “0”, and when image group is determined to be not the still scene, set the offset value to “0”.

5. The information processing apparatus according to claim 4,
wherein the processor is configured to
generate the predictive image by the inter-prediction and, by using the image to be subjected to temporal scalable coding and the predictive image, calculate sum of absolute difference of the image with respect to the predictive image, and
calculate the offset value based on the sum of absolute difference.

6. The information processing apparatus according to claim 5,
wherein the processor is configured to
calculate the sum of absolute difference on a per-prediction block basis in the image, and
calculate the offset value based on the sum of absolute difference.

7. The information processing apparatus according to claim 5,
wherein the processor is configured to
calculate the sum of absolute difference for one image on a per-prediction block basis in the image, and
based on mean sum of absolute difference obtained by averaging the sum of absolute difference by the number of prediction blocks corresponding to one image, calculate the offset value.

8. The information processing apparatus according to claim 5,
wherein the image group is a plurality of images included in a structure of pictures (SOP) in temporal scalable coding, and
wherein the processor is configured to
calculate, in the SOP, the sum of absolute difference between a plurality of images one or a plurality of SOPs preceding the image to be subjected to temporal scalable coding with temporary identification (TID) at the same level as the image to be subjected to temporal scalable coding and the image to be subjected to temporal scalable coding, or the sum of absolute difference between a plurality of images a plurality of SOPs preceding the image to be subjected to temporal scalable coding in the same encoding order as the image to be subjected to temporal scalable coding, and
based on a mean of the sum of absolute difference, calculate the offset value.

9. The information processing apparatus according to claim 5,
wherein the image group is a plurality of images included in a structure of pictures (SOP) in temporal scalable coding, and
wherein the processor is configured to
calculate, in the SOP, the sum of absolute difference between a plurality of images with temporary identification (TID) “0” and the image to be subjected to temporal scalable coding, and
based on a mean of the sum of absolute difference, calculate the offset value.

10. The information processing apparatus according to claim 4,
wherein the processor is configured to
when the image group is determined to be the still scene, calculate the offset value greater than “0” for all images included in the image group, and
add the offset value to an intra-prediction encoding cost of the all images included in the image group.

11. The information processing apparatus according to claim 1,
wherein the processor is configured to
by using a predictive image generated in the inter-prediction mode, calculate an inter-prediction encoding cost, and
based on the intra-prediction encoding cost to which the offset value is added, and the inter-prediction encoding cost, select the inter-prediction mode in which a predictive image of the image included in the image group is generated by inter prediction or an intra-prediction mode in which a predictive image of the image included in the image group is generated by intra-prediction.

12. An information processing method executed by a computer, comprising:
by using image data of an image to be subjected to temporal scalable coding, obtaining a motion vector for the image,
based on the motion vector, determining whether an image group to be encoded is a still scene,
when the image group is determined to be the still scene, adding an offset value to an intra-prediction encoding cost of the image included in the image group,
based on an intra-prediction encoding cost to which the offset value is added, selecting an inter-prediction mode in which a predictive image of the image included in the image group is generated by inter-prediction, and
by utilizing image data of the predictive image, performing an encoding process on the image data of the image included in the image group.

13. A non-transitory computer-readable recording medium storing therein a program for causing a computer to execute a process, the process comprising:
by using image data of an image to be subjected to temporal scalable coding, obtaining a motion vector for the image,
based on the motion vector, determining whether an image group to be encoded is a still scene,
when the image group is determined to be the still scene, adding an offset value to an intra-prediction encoding cost of the image included in the image group,
based on an intra-prediction encoding cost to which the offset value is added, selecting an inter-prediction mode in which a predictive image of the image included in the image group is generated by inter-prediction, and
by utilizing image data of the predictive image, performing an encoding process on the image data of the image included in the image group.
